(19) United States
(12) Patent Application Publication
(10) Pub. No.: US 2026/0009396 A1
(43) Pub. Date: Jan. 8, 2026

(54) RADIAL MAGNETIC BEARING, COMPRESSOR, AND REFRIGERATOR

(71) Applicant: DAIKIN INDUSTRIES, LTD., Osaka (JP)

(72) Inventors: Kenta TAGAMI, Osaka (JP); Tatsuya TONARI, Osaka (JP); Yuu FU, Osaka (JP)

(21) Appl. No.: 19/325,191

(22) Filed: Sep. 10, 2025

Related U.S. Application Data
(63) Continuation of application No. PCT/JP2024/011925, filed on Mar. 26, 2024.

(30) Foreign Application Priority Data
Mar. 31, 2023 (JP) 2023-057661

(51) Int. Cl. F04D 29/058; F16C 32/04

(52) U.S. Cl. CPC F04D 29/058; F16C 32/0459; F16C 32/048

(57) ABSTRACT

A radial magnetic bearing includes a tubular yoke, teeth projecting inward from the yoke in a radial direction of the yoke, slots surrounded by the teeth and the yoke, a first coil wound around one of the teeth, and a second coil wound around an other one of the teeth different from the one of the teeth around which the first coil is wound. The teeth are spaced apart in a circumferential direction of the yoke. The slots are open inward in the radial direction. A part of the first coil and a part of the second coil are both disposed in a predetermined one of the slots. In the predetermined one of the slots, the part of the second coil is disposed inward from the part of first coil in the radial direction.

### CROSS-REFERENCE TO RELATED APPLICATIONS

This application is a continuation of, and claims the benefit of priority from International Application No. PCT/JP2024/011925, filed on Mar. 26, 2024, which claims the benefit of priority from Japanese Patent Application No. 2023-057661, filed on Mar. 31, 2023, the entire contents of each are incorporated herein by reference.

### BACKGROUND

### Technical Field

The present disclosure relates to a radial magnetic bearing, a compressor, and a refrigeration machine.

### Background Information

A radial magnetic bearing supports a rotating body in a non-contact manner. JP2021-143640A discloses an example of a radial magnetic bearing including a yoke, teeth, slots surrounded by the yoke and the teeth, a first coil, and a second coil. In the radial magnetic bearing of JP2021-143640A, a part of the first coil and a part of the second coil are arranged in the same slot.

### SUMMARY

In one general aspect, a radial magnetic bearing is configured to support a rotating body. The radial magnetic bearing includes a tubular yoke, teeth, slots, a first coil, and a second coil. The teeth project inward from the yoke in a radial direction of the yoke, and the teeth are spaced apart in a circumferential direction of the yoke. The slots are surrounded by the teeth and the yoke, and the slots are open inward in the radial direction. The first coil is wound around one of the teeth. The second coil is wound around a further one of the teeth that differs from the one of the teeth around which the first coil is wound. A part of the first coil and a part of the second coil are both disposed in a predetermined one of the slots. In the predetermined one of the slots, the part of the second coil is disposed inward from the part of first coil in the radial direction.

### BRIEF DESCRIPTION OF DRAWINGS

FIG. 1 is a schematic diagram illustrating a refrigeration machine of a first embodiment.

FIG. 2 is a cross-sectional view illustrating a radial magnetic bearing shown in FIG. 1.

FIG. 3 is a schematic diagram illustrating the magnetic flux generated by coils shown in FIG. 2.

FIG. 4 is a schematic diagram illustrating a first coil group shown in FIG. 2.

FIG. 5 is a cross-sectional view illustrating part of the radial magnetic bearing shown in FIG. 2.

FIG. 6 is a cross-sectional view illustrating a radial magnetic bearing of a second embodiment.

FIG. 7 is a schematic diagram illustrating a modified example of the first coil group shown in FIG. 2.

### DETAILED DESCRIPTION OF EMBODIMENT(S)

### First Embodiment

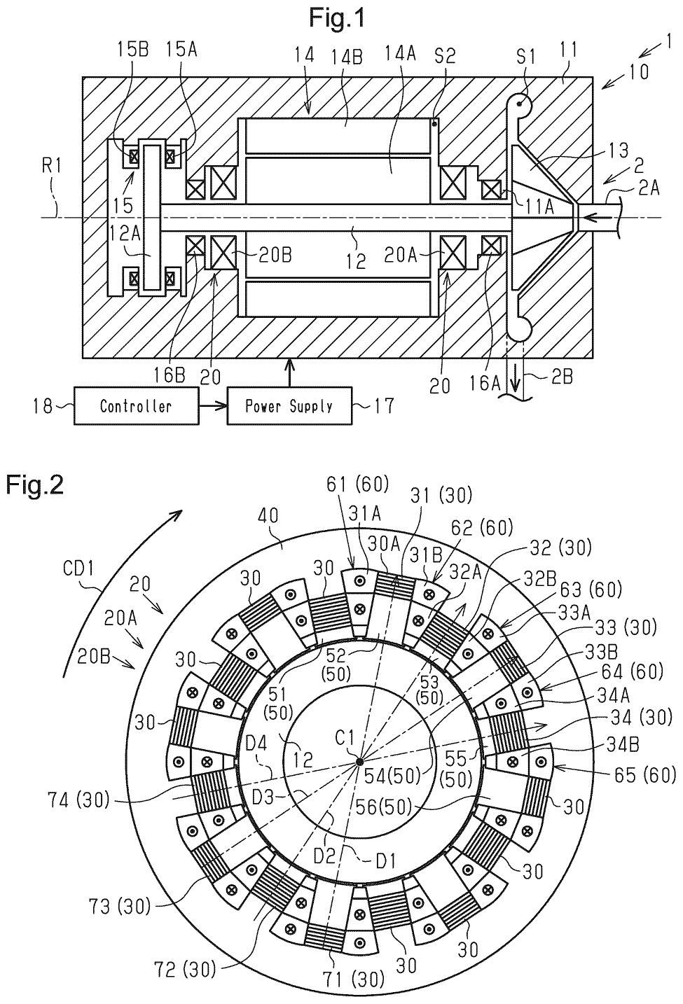

A refrigeration machine 1, a compressor 10, and a radial magnetic bearing 20 in accordance with a first embodiment will now be described with reference to FIGS. 1 to 5.

### The Refrigeration Machine

As shown in FIG. 1, the refrigeration machine 1 includes a refrigerant circuit 2 through which a refrigerant is circulated. An example of the refrigeration machine 1 is a turbo refrigeration machine. The refrigerant circuit 2 includes a first path 2A and a second path 2B. The refrigeration machine 1 includes the compressor 10. The compressor 10 is located between the first path 2A and the second path 2B.

### The Compressor

The compressor 10 is arranged in the refrigerant circuit 2 to compress the refrigerant gas circulating through the refrigerant circuit 2. An example of the compressor 10 is a turbo compressor. The compressor 10 includes, for example, a case 11. The case 11 is divided into an impeller housing S1 and a motor housing S2 by a wall 11A.

The compressor 10 includes a rotating body 12 and the radial magnetic bearing 20. The rotating body 12 is, for example, a rotation shaft having a rotation axis R1. The rotating body 12 is configured to rotate relative to the case 11 about the rotation axis R1. The rotating body 12 is disposed in the case 11 so as to extend through the impeller housing S1 and the motor housing S2. The rotating body 12 includes a disk 12A rotated about the rotation axis R1.

The compressor 10 includes, for example, an impeller 13. The impeller 13 is disposed in the impeller housing S1. The impeller 13 includes blades and has a generally conical shape. The impeller 13 is arranged on one end of the rotating body 12. Rotation of the rotating body 12 about the rotation axis R1 rotates the impeller 13 about the rotation axis R1.

The impeller 13 and the impeller housing S1 form a compression mechanism. Refrigerant gas flows into the impeller housing S1 through the first path 2A. The refrigerant gas is compressed by the impeller 13 into a fluid of refrigerant. The refrigerant compressed in the impeller housing S1 flows out of the impeller housing S1 through the second path 2B.

The compressor 10 includes, for example, a motor 14. The motor 14 is configured to rotate the rotating body 12 with electromagnetic force. The motor 14 is disposed in the motor housing S2. The motor 14 includes a rotor 14A and a stator 14B. The rotor 14A is coupled to the rotating body 12. The stator 14B is coupled to a circumferential wall of the case 11 in the compressor 10.

The radial magnetic bearing 20 supports the rotating body 12 that includes a radial magnetic bearing rotor coupled to the rotation shaft. The radial magnetic bearing 20 is configured to support the rotating body 12 in a non-contact manner with electromagnetic force. The radial magnetic bearing 20 is arranged separately from the motor 14. The radial magnetic bearing 20 is disposed in the motor housing S2.

The radial magnetic bearing 20 includes a first radial electromagnet 20A and a second radial electromagnet 20B. The first radial electromagnet 20A is disposed on one end of the rotating body 12, and the second radial electromagnet 20B is arranged on the other end of the rotating body 12. The current flowing through the first radial electromagnet 20A and the second radial electromagnet 20B is controlled to control the electromagnetic force of the first radial electromagnet 20A and the second radial electromagnet 20B. The electromagnetic force of the first radial electromagnet 20A and the second radial electromagnet 20B controls the position of the rotating body 12 in a direction orthogonal to the rotation axis R1 and the inclination of the rotating body 12 relative to the case 11.

The compressor 10 includes, for example, a thrust magnetic bearing 15. The thrust magnetic bearing 15 is configured to support the disk 12A in a non-contact manner with electromagnetic force. The thrust magnetic bearing 15 is disposed in the motor housing S2.

The thrust magnetic bearing 15 includes a first thrust electromagnet 15A and a second thrust electromagnet 15B. The first thrust electromagnet 15A and the second thrust electromagnet 15B sandwich the disk 12A in a direction parallel to the rotation axis R1. The current flowing through the first thrust electromagnet 15A and the second thrust electromagnet 15B is controlled to control the electromagnetic force of the first thrust electromagnet 15A and the second thrust electromagnet 15B. The electromagnetic force of the first thrust electromagnet 15A and the second thrust electromagnet 15B is controlled to control the position of the rotating body 12 in the direction parallel to the rotation axis R1 with the disk 12A.

The compressor 10 includes, for example, a first touchdown bearing 16A and a second touchdown bearing 16B. The first touchdown bearing 16A and the second touchdown bearing 16B are disposed in the motor housing S2. The first touchdown bearing 16A is arranged on one end of the rotating body 12, and the second touchdown bearing 16B is arranged on the other end of the rotating body 12. When the radial magnetic bearing 20 does not support the rotating body 12, the first touchdown bearing 16A and the second touchdown bearing 16B contact the rotating body 12 to support the rotating body 12.

The compressor 10 includes, for example, a power supply 17 and a controller 18. The power supply 17 and the controller 18 may be arranged inside the case 11 or outside the case 11. The power supply 17 is formed by, for example, a Pulse Width Modulation (PWM) amplifier. The power supply 17 applies voltage to the radial magnetic bearing 20, the thrust magnetic bearing 15, and the motor 14.

The controller 18 includes, for example, a processor such as a CPU and, storage such as memory storing information and programs for operating the processor. The controller 18 controls the supply of electric power from the power supply 17 to the radial magnetic bearing 20 and the thrust magnetic bearing 15 based on outputs of sensors. The sensors are, for example, position sensors configured to detect the position of the rotating body 12 in the case 11. The position sensors are disposed in the case 11 to detect the position of the rotating body 12 in the direction parallel to the rotation axis R1, the position of the rotating body 12 in the direction orthogonal to the rotation axis R1, and the inclination of the rotating body 12 relative to the case 11.

### The Radial Magnetic Bearing

As shown in FIG. 2, the radial magnetic bearing 20 includes coils 30 that generate electromagnetic force. The radial magnetic bearing 20 supports the rotating body 12 in a non-contact manner with the electromagnetic force generated by the coils 30. The radial magnetic bearing 20 includes a tubular yoke 40, teeth 50, slots 60, a first coil 31, and a second coil 32. The radial magnetic bearing 20 includes a third coil 33. The first radial electromagnet 20A and the second radial electromagnet 20B each include the coils 30, the yoke 40, the teeth 50, and the slots 60. FIG. 2 shows one of the first radial electromagnet 20A and the second radial electromagnet 20B. The first radial electromagnet 20A and the second radial electromagnet 20B are identical in structure.

### The Yoke

The yoke 40 is formed from a magnetic material. The yoke 40 is formed from, for example, a laminate of steel plates, amorphous metal or Permendur. The yoke 40 has a center axis C1 coinciding with the rotation axis R1. In the description hereafter, the axial direction refers to the axial direction of the yoke 40. The axial direction of the yoke 40 is a direction parallel to the center axis C1. The radial direction refers to the radial direction of the yoke 40. The radial direction of the yoke 40 is a direction orthogonal to the center axis C1. The circumferential direction refers to the circumferential direction of the yoke 40. The circumferential direction of the yoke 40 is a direction extending about the center axis C1.

### The Teeth

The coils 30 are wound around the teeth 50. The number of the teeth 50 is set in accordance with the number of the coils 30. In the present embodiment, there are sixteen teeth 50. The teeth 50 are formed from a magnetic material. The teeth 50 are formed from, for example, a laminate of steel plates composed of either amorphous metal or Permendur. The teeth 50 are formed integrally with the yoke 40 so as to project inward in the radial direction from the inner circumferential surface of the yoke 40. The teeth 50 project inward from the yoke 40 in the radial direction of the yoke 40 and are spaced apart in the circumferential direction of the yoke 40.

The teeth 50 includes a first tooth 51, a second tooth 52, a third tooth 53, and a fourth tooth 54. The second tooth 52 is spaced apart from the first tooth 51 in a first circumferential direction CD1. The third tooth 53 is spaced apart from the second tooth 52 in the first circumferential direction CD1. The fourth tooth 54 is spaced apart from the third tooth 53 in the first circumferential direction CD1. The teeth 50 include a fifth tooth 55. The fifth tooth 55 is spaced apart from the fourth tooth 54 in the first circumferential direction CD1. The teeth 50 include, for example, a sixth tooth 56. The sixth tooth 56 is spaced apart from the fifth tooth 55 in the first circumferential direction CD1.

### The Slots

The coils 30 are disposed in the slots 60. In the present embodiment, two coils 30 are disposed in each slot 60. The slots 60 are each surrounded by the corresponding teeth 50 and the yoke 40 and open inward in the radial direction. The number of the slots 60 is, for example, the same as the number of the teeth 50. In the present embodiment, there are sixteen slots 60. The slots 60 are each formed so that the width in the circumferential direction decreases toward the radially inner side.

The slots 60 include a first slot 61, a second slot 62, and a third slot 63. The first slot 61 is surrounded by the yoke 40, the first tooth 51, and the second tooth 52. The second slot 62 is surrounded by the yoke 40, the second tooth 52, and the third tooth 53. The third slot 63 is surrounded by the yoke 40, the third tooth 53, and the fourth tooth 54. The slots 60 include a fourth slot 64. The fourth slot 64 is surrounded by the yoke 40, the fourth tooth 54, and the fifth tooth 55. The slots 60 include, for example, a fifth slot 65. The fifth slot 65 is surrounded by the yoke 40, the fifth tooth 55, and the sixth tooth 56.

### The Coils

The coils 30 are configured to generate electromagnetic force when energized to support the rotating body 12 in a non-contact manner. The coils 30 are wound around the teeth 50 so as to pass through two of the slots 60. The coils 30 are formed by strands 30A. The strands 30A are, for example, electric wires. The coils 30 are formed by winding the strands 30A in a concentrated winding configuration around the teeth 50.

One of the coils 30 is formed by, for example, winding the strands 30A in a concentrated winding configuration around one of the teeth 50. In the present embodiment, there are sixteen coils 30. The coils 30 include, for example, the first coil 31, the second coil 32, the third coil 33, and a fourth coil 34.

The first coil 31 is wound around one of the teeth 50. The first coil 31 is wound around the second tooth 52. The first coil 31 includes a first part 31A disposed in the first slot 61, and a second part 31B disposed in the second slot 62. In the present embodiment, the first part 31A of the first coil 31 and the second part 31B of the first coil 31 are disposed at opposite sides of the second tooth 52 and located at overlapping positions in the circumferential direction.

The second coil 32 is wound around a tooth 50 that differs from the tooth 50 around which the first coil 31 is wound. The second coil 32 is wound around the third tooth 53. The second coil 32 includes a third part 32A disposed in the second slot 62, and a fourth part 32B disposed in the third slot 63. In the present embodiment, the third part 32A of the second coil 32 and the fourth part 32B of the second coil 32 are disposed at opposite sides of the third tooth 53 and located at overlapping positions in the circumferential direction.

A part of the first coil 31 and a part of the second coil 32 are both disposed in a predetermined one of the slots 60. In the predetermined slot 60, the part of the second coil 32 is disposed inward from the part of the first coil 31 in the radial direction. The predetermined slot 60, in which the part of the first coil 31 and the part of the second coil 32 are disposed, is, for example, the second slot 62. In the second slot 62, the third part 32A is disposed inward from the second part 31B in the radial direction.

The third coil 33 is wound around a tooth 50 that differs from the teeth 50 around which the first coil 31 and the second coil 32 are wound. The third coil 33 is wound around the fourth tooth 54. The third coil 33 includes a fifth part 33A disposed in the third slot 63, and a sixth part 33B disposed in the fourth slot 64. In the present embodiment, the fifth part 33A of the third coil 33 and the sixth part 33B of the third coil 33 are disposed at opposite sides of the fourth tooth 54 and located at overlapping positions in the circumferential direction.

A part of the second coil 32 and a part of the third coil 33 are both disposed in the same slot 60. In the slot 60, the part of the third coil 33 is disposed outward from the part of the second coil 32 in the radial direction. The slot 60, in which the part of the second coil 32 and the part of the third coil 33 are disposed, is, for example, the third slot 63. In the third slot 63, the fifth part 33A is disposed outward from the fourth part 32B in the radial direction.

The fourth coil 34 is wound around, for example, a tooth 50 that differs from the teeth 50 around which the first coil 31, the second coil 32, and the third coil 33 are wound. The fourth coil 34 is wound around, for example, the fifth tooth 55. The fourth coil 34 includes, for example, a seventh part 34A disposed in the fourth slot 64, and an eighth part 34B disposed in the fifth slot 65. In the present embodiment, the seventh part 34A of the fourth coil 34 and the eighth part 34B of the fourth coil 34 are disposed at opposite sides of the fifth tooth 55 and located at overlapping positions in the circumferential direction.

A part of the third coil 33 and a part of the fourth coil 34 are both disposed in the same slot 60. In the slot 60, the part of the fourth coil 34 is disposed inward from the part of the third coil 33 in the radial direction. The slot 60, in which the part of the third coil 33 and the part of the fourth coil 34 are disposed, is, for example, the fourth slot 64. In the fourth slot 64, the seventh part 34A is disposed inward from the sixth part 33B in the radial direction.

In the present embodiment, the radial magnetic bearing 20 includes a first additional coil 71 and a second additional coil 72. The radial magnetic bearing 20 includes, for example, a third additional coil 73 and a fourth additional coil 74. The coils 30 include the first additional coil 71, the second additional coil 72, the third additional coil 73, and the fourth additional coil 74.

The first additional coil 71 is wound around the tooth 50 facing, in a first direction D1 orthogonal to the axial direction of the yoke 40, the tooth 50 around which the first coil 31 is wound. The tooth 50 facing, in the first direction D1, the tooth 50 around which the first additional coil 71 is wound is, for example, the second tooth 52. The second additional coil 72 is wound around the tooth 50 facing, in a second direction D2 orthogonal to the axial direction, the tooth 50 around which the second coil 32 is wound. The tooth 50 facing, in the second direction D2, the tooth 50 around which the second additional coil 72 is wound is, for example, the third tooth 53. The third additional coil 73 is wound around the tooth 50 facing, in a third direction D3 orthogonal to the axial direction, the tooth 50 around which the third coil 33 is wound. The tooth 50 facing, in the third direction D3, the tooth 50 around which the third additional coil 73 is wound is, for example, the fourth tooth 54. The fourth additional coil 74 is wound around the tooth 50 facing, in a fourth direction D4 orthogonal to the axial direction, the tooth 50 around which the fourth coil 34 is wound. The tooth 50 facing, in the fourth direction D4, the tooth 50 around which the fourth additional coil 74 is, for example, the fifth tooth 55.

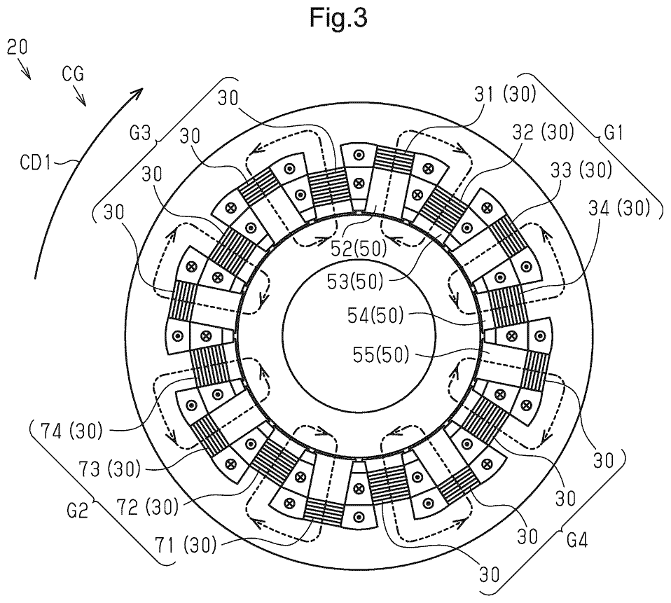

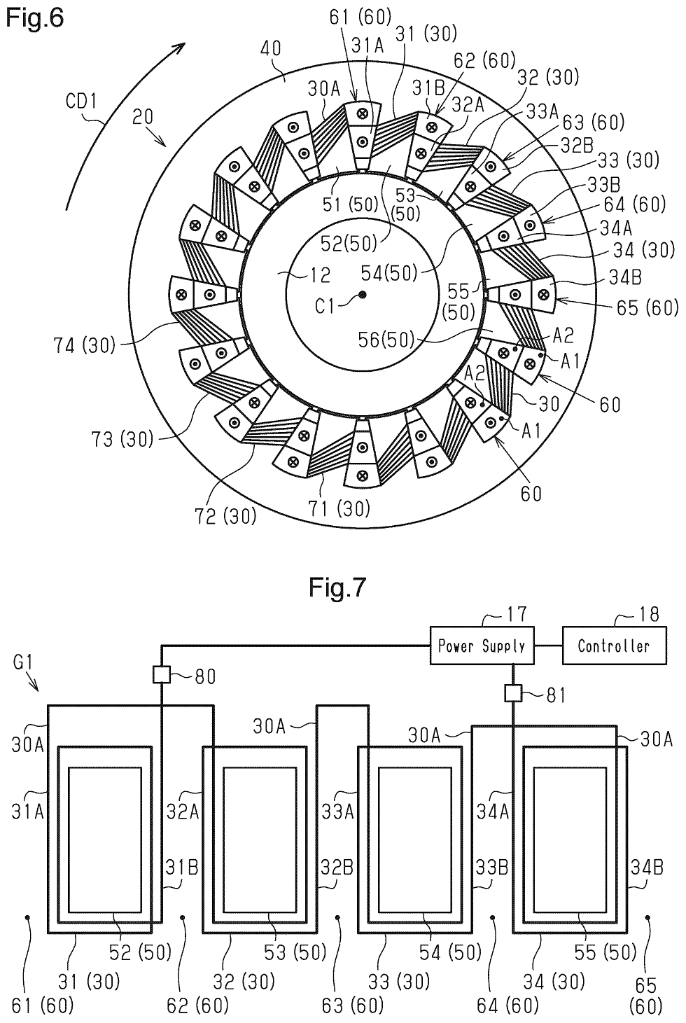

In the example of FIG. 2, two symbols are used to indicate the directions in which current flows through the parts of the coils 30 disposed in the slots 60 when the radial magnetic bearing 20 is energized. The first part 31A of the first coil 31 is depicted with a symbol denoting current flow toward the viewer from the plane of the drawing. The second part 31B of the first coil 31 is depicted with a symbol denoting current flow away from the viewer toward the plane of the drawing. In FIGS. 3 and 6, the directions in which current flows through the parts of the coils 30 disposed in the slots 60 are also indicated by the same symbols as FIG. 2.

### Coil Groups

As shown in FIG. 3, the coils 30, which generate electromagnetic force, of the radial magnetic bearing 20 are divided into coil groups CG. In each coil group CG, the coils 30 are electrically connected in series. There are four coil groups CG. The four coil groups CG are arranged at intervals of 90° in the circumferential direction.

In the present embodiment, the radial magnetic bearing 20 includes a first coil group G1 and a second coil group G2. The second coil group G2 faces the first coil group G1 in the radial direction. In the present embodiment, the radial magnetic bearing 20 includes a third coil group G3 and a fourth coil group G4. The fourth coil group G4 faces the third coil group G3 in the radial direction.

The coil groups CG each include one or more coils 30. The number of the coils 30 in each coil group CG is set by, for example, dividing the number of the coils 30 by the number of the coil groups CG. In the present embodiment, there are sixteen coils 30. Thus, there are four coils 30 in each coil group CG. If there were eight coils 30, each coil group CG would have two coils 30. If there were thirty-two coils 30, each coil group CG would have eight coils 30.

The first coil group G1 includes the first coil 31 and the second coil 32. Further, the first coil group G1 includes the third coil 33 and the fourth coil 34. The second coil group G2 includes the first additional coil 71 and the second additional coil 72. Further, the second coil group G2 includes the third additional coil 73 and the fourth additional coil 74. The third coil group G3 includes four coils 30 wound around the teeth 50, which are arranged next to one another in the circumferential direction. The fourth coil group G4 includes four coils 30 wound around the teeth 50, which are arranged next to one another in the circumferential direction.

### Operation of Radial Magnetic Bearing

In FIG. 3, the broken lines indicate the magnetic flux generated by the coils 30 when the radial magnetic bearing 20 is energized. When the radial magnetic bearing 20 is energized, the teeth 50 that are adjacent to each other form an S-pole and an N-pole. For example, the second tooth 52, around which the first coil 31 is wound, forms an S-pole, and the third tooth 53, around which the second coil 32 is wound, forms an N-pole. For example, the fourth tooth 54, around which the third coil 33 is wound, forms an S-pole, and the fifth tooth 55, around which the fourth coil 34 is wound, forms an N-pole.

The radial magnetic bearing 20 supports the rotating body 12 in a non-contact manner with the electromagnetic force generated by the magnetic flux of the coils 30. The coil groups CG generate electromagnetic force that attracts the rotating body 12. The electromagnetic force of the first coil group G1 and the second coil group G2 acts on the rotating body 12 in the radial direction to support the rotating body 12 in a non-contact manner between the first coil group G1 and the second coil group G2. The electromagnetic force of the third coil group G3 and the fourth coil group G4 acts on the rotating body 12 to support the rotating body 12 in a non-contact manner between the third coil group G3 and the fourth coil group G4. The electromagnetic force of the four coil groups CG is controlled so that the radial magnetic bearing 20 supports the rotating body 12 in a direction orthogonal to the axial direction.

### Connection of the Coils

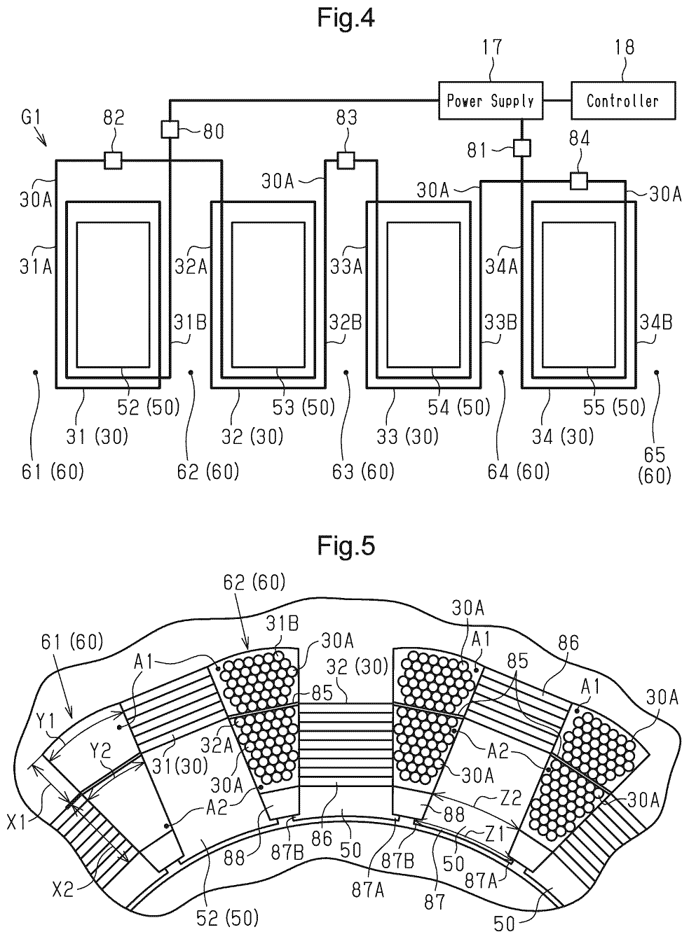

FIG. 4 is a schematic diagram illustrating the first coil group G1 from the radially inner side. The second coil group G2, the third coil group G3, and the fourth coil group G4 have the same configuration as the first coil group G1. As shown in FIG. 4, the coils 30 that are in the same coil group CG are electrically connected in series. The first coil 31 is electrically connected to the second coil 32. In the present embodiment, the first coil 31, the second coil 32, the third coil 33, and the fourth coil 34 are electrically connected.

The coils 30 include a first end 80, a second end 81, a first connection 82, a second connection 83, and a third connection 84. The first end 80 and the second end 81 are electrically connected to the power supply 17. The first connection 82 electrically connects the strands 30A of the first coil 31 to the strands 30A of the second coil 32. The second connection 83 electrically connects the strands 30A of the second coil 32 to the strands 30A of the third coil 33. The third connection 84 electrically connects the strands 30A of the third coil 33 to the strands 30A of the fourth coil 34. The first connection 82, the second connection 83, and the third connection 84 are disposed outside the slots 60.

The strands 30A at one end of the first coil 31 extend out of the slots 60 from the first slot 61, and the strands 30A at the other end of the first coil 31 extend out of the slots 60 from the second slot 62. The strands 30A at one end of the first coil 31 are electrically connected to the first connection 82. The strands 30A at the other end of the first coil 31 are electrically connected to the power supply 17. The strands 30A at the other end of the first coil 31 define, for example, the first end 80.

The strands 30A at one end of the second coil 32 extend out of the slots 60 from the second slot 62, and the strands 30A at the other end of the second coil 32 extend out of the slots 60 from the third slot 63. The strands 30A at one end of the second coil 32 are electrically connected to, for example, the first connection 82. The strands 30A at the other end of the second coil 32 are electrically connected to, for example, the second connection 83.

The strands 30A at one end of the third coil 33 extend out of the slots 60 from the third slot 63, and the strands 30A at the other end of the third coil 33 extend out of the slots 60 from the fourth slot 64. The strands 30A at one end of the third coil 33 are electrically connected to, for example, the second connection 83. The strands 30A at the other end of the third coil 33 are electrically connected to, for example, the third connection 84.

The strands 30A at one end of the fourth coil 34 extend out of the slots 60 from the fourth slot 64, and the strands 30A at the other end of the fourth coil 34 extend out of the slots 60 from the fifth slot 65. The strands 30A at one end of the fourth coil 34 are electrically connected to the power supply 17. The strands 30A at one end of the fourth coil 34 are electrically connected to, for example, the second end 81. The strands 30A at the other end of the fourth coil 34 are electrically connected to, for example, the third connection 84.

### First Region and Second Region

FIG. 5 is an enlarged view showing part of the radial magnetic bearing 20 in the axial direction of the yoke 40. FIG. 5 does not show the strands 30A disposed in the first slot 61. As shown in FIG. 5, the slots 60 are each divided into a first region A1, where a part of a coil 30 is disposed, and a second region A2, where a part of an adjacent coil 30 is disposed. The second region A2 is located inward in the radial direction from the first region A1. The second region A2 is equal in area to the first region A1 as viewed in the axial direction of the yoke 40. In the present embodiment, when the strands 30A of a coil 30 are disposed in the first region A1 of a slot 60, the strands 30A of the coil 30 are also disposed in the first region A1 of the adjacent slot 60. When the strands 30A of a coil 30 are disposed in the second region A2 of a slot 60, the strands 30A of the coil 30 are also disposed in the second region A2 of the adjacent slot 60.

The predetermined slot 60 includes the first region A1, where a part of the first coil 31 is disposed, and the second region A2, where a part of the second coil 32 is disposed. The predetermined slot 60 is, for example, the second slot 62. The second part 31B of the first coil 31 is disposed in the first region A1 of the second slot 62, and the third part 32A of the second coil 32 is disposed in the second region A2 of the second slot 62.

The first part 31A of the first coil 31 is disposed in the first region A1 of a slot 60, and the second part 31B of the first coil 31 is disposed in the first region A1 of the slot 60 adjacent to the slot 60 where the first part 31A is disposed. The first part 31A of the first coil 31 is disposed in the first region A1 of the first slot 61, and the second part 31B of the first coil 31 is disposed in the first region A1 of the second slot 62. The third part 32A of the second coil 32 is disposed in the second region A2 of a slot 60, and the fourth part 32B of the second coil 32 is disposed in the second region A2 of the slot 60 adjacent to the slot 60 where the third part 32A is disposed. The third part 32A of the second coil 32 is disposed in the second region A2 of the second slot 62, and the fourth part 32B of the second coil 32 is disposed in the second region A2 of the third slot 63.

The first region A1 and the second region A2, for example, extend in the radial direction. In the present embodiment, the first region A1, for example, extends in the radial direction of the corresponding slot 60 from an insulator 85 to the inner circumferential surface of the yoke 40. In the present embodiment, the second region A2, for example, extends in the radial direction of the corresponding slot 60 from the outer circumferential surface of a coil positioning member 88 to the insulator 85.

In the radial direction, a dimension X2 of the second region A2 is larger than a dimension X1 of the first region A1. The dimension X1 of the first region A1 in the radial direction is, for example, taken along a circumferential side surface of the corresponding tooth 50 in the first region A1. The dimension X2 of the second region A2 in the radial direction is, for example, taken along a circumferential side surface of the corresponding tooth 50 in the second region A2.

The first region A1 and the second region A2, for example, extend in the circumferential direction. The first region A1 and the second region A2, for example, extend in the circumferential direction from one of the two teeth 50 located at opposite sides of the corresponding slot 60 to the other one of the two teeth 50 located at opposite sides of the corresponding slot 60. In the circumferential direction, a dimension Y2 of the second region A2 is smaller than a dimension Y1 of the first region A1. The dimension Y1 of the first region A1 in the circumferential direction is, for example, taken along the radially outer side of the first region A1. The dimension Y1 of the first region A1 in the circumferential direction is, for example, the dimension of the inner circumferential surface of the yoke 40 in the corresponding slot 60. The dimension Y2 of the second region A2 in the circumferential direction is, for example, taken along the radially outer side of the second region A2. The dimension Y2 of the second region A2 in the circumferential direction is, for example, the dimension of the insulator 85 disposed in the corresponding slot 60.

One of the coils 30 has a number of turns equal to that of other coils 30. The second coil 32 has a number of turns equal to that of the first coil 31. The third coil 33 has a number of turns equal to that of the first coil 31, and the fourth coil 34 has a number of turns equal to that of the first coil 31.

The strands 30A of the coils 30 have substantially the same cross-sectional area as viewed in the axial direction. The number of winds of a coil 30 is equal to the number of coils of another coil 30. Thus, the number of strands 30A disposed in the second region A2 is equal to the number of strands 30A disposed in the first region A1. The second region A2 has a slot fill factor equal to that of the first region A1. The slot fill factor is defined as the ratio of the total cross-sectional area of the strands 30A of the coil 30 passing through a slot 60 to the cross-sectional area of the slot 60. The slot fill factor of the first region A1 is defined as the ratio of the total cross-sectional area of the strands 30A of the coil 30 passing through the first region A1 to the cross-sectional area of the first region A1. The slot fill factor of the second region A2 is defined as the ratio of the total cross-sectional area of the strands 30A of the coil 30 passing through the second region A2 to the cross-sectional area of the second region A2.

### The Insulator

The radial magnetic bearing 20 includes the insulator 85 located, in the radial direction, between the strands 30A disposed in the first region A1 of the corresponding slot 60 and the strands 30A disposed in the second region A2 of the corresponding slot 60. The insulator 85 is disposed in the predetermined slot 60 between a part of the first coil 31 and a part of the second coil 32 in the radial direction. In the second slot 62, the insulator 85 extends in the circumferential direction between the second part 31B of the first coil 31 and the third part 32A of the second coil 32. The insulator 85 is disposed in, for example, every one of the slots 60. The insulator 85 is, for example, an insulating paper. The insulator 85, for example, partitions the corresponding slot 60 into the first region A1 and the second region A2.

### The Coil Winding Portion and the Coil Stopper Portion

Each tooth 50 includes a coil winding portion 86, around which the corresponding coil 30 is wound, and a coil stopper portion 87, located inward from the coil winding portion 86 in the radial direction. In the circumferential direction, a dimension Z1 of the coil stopper portion 87 is larger than a dimension Z2 of the coil winding portion 86.

The coil stopper portion 87 includes, for example, a first projection 87A, which projects in the first circumferential direction CD1 from the side surface of the tooth 50, and a second projection 87B, which projects in a direction opposite the first circumferential direction CD1 from the side surface of the tooth 50. The first projection 87A and the second projection 87B overlap the coils 30 as viewed in the radial direction.

### The Coil Positioning Member

The radial magnetic bearing 20 includes the coil positioning member 88. The coil positioning member 88 is disposed in the predetermined slot 60 and extends in the circumferential direction from a side surface of one of the teeth 50 located at opposite sides of the predetermined slot 60 to the other one of the teeth 50 located at opposite sides of the predetermined slot 60. The coil positioning member 88 is disposed in, for example, every one of the slots 60. The coil positioning member 88 disposed in the second slot 62, for example, extends in the circumferential direction from a side surface of the second tooth 52 to a side surface of the third tooth 53.

The coil positioning member 88 is located inward from the coils 30 in the radial direction. The coil positioning member 88 overlaps the coils 30 as viewed in the radial direction. The coil positioning member 88 is located inward from the first coil 31 and the second coil 32 in the radial direction. The coil positioning member 88 overlaps the first coil 31 and the second coil 32 as viewed in the radial direction. The coil positioning member 88 overlaps, in the radial direction, the first projection 87A of one of the teeth 50 located at opposite sides of the predetermined slot 60 and the second projection 87B of the other one of the teeth 50 located at opposite sides of the predetermined slot 60.

The coil positioning member 88, which is shaped in conformance with each slot 60, has a width in the circumferential direction that decreases toward the radially inner side. The coil positioning member 88 is disposed in the corresponding slot 60 so as to close the slot 60. The coil positioning member 88 is, for example, a wedge.

### Coil Formation Method

With reference to FIGS. 3 to 5, a method for forming the coils 30 in the present embodiment will now be described. The method for forming the coils 30 in the present embodiment includes a first step, a second step, a third step, a fourth step, a fifth step, and a sixth step.

The first step tentatively forms the coils 30 with the strands 30A. In the first step, the strands 30A are wound around a wooden former shaped in correspondence with a tooth 50 to tentatively form a coil 30. After the coil 30 is tentatively formed, the wooden former is removed from the coil 30.

The second step disposes one of the coils 30 in the first regions A1 so as to wind the coil 30 around the corresponding tooth 50. In the second step, the coil 30, which is to be disposed in the first regions A1, is inserted from the openings of the slots 60 and wound around the tooth 50.

The third step rearranges the strands 30A of the coil 30 in the first regions A1 to reshape the coil 30 in the first regions A1. In the third step, the strands 30A of the coil 30, tentatively formed in the first step and disposed in the first regions A1, are loosened and then rearranged in conformance with the shape of the first regions A1.

The fourth step disposes one of the coils 30 in the second regions A2 and winds the coil 30 around the corresponding tooth 50. In the fourth step, the coil 30, which is to be disposed in the second regions A2, is inserted from the openings of the slots 60 and wound around the tooth 50.

The fifth step rearranges the strands 30A of the coil 30 in the second regions A2 to reshape the coil 30 in the second regions A2. In the fifth step, the strands 30A of the coil 30, tentatively formed in the first step and disposed in the second regions A2, are loosened and then rearranged in conformance with the shape of the second regions A2.

The sixth step electrically connects the coils 30. In the sixth step, the coils 30 are electrically connected in each coil group CG.

In the fourth step, the insulator 85 may be disposed in each slot 60 before the coil 30 disposed in the second regions A are wound around the tooth 50. The coil positioning member 88 may be disposed in each slot 60 after the sixth step. The coil positioning member 88 may be, for example, inserted into each slot 60 in the axial direction.

In the first step, the coils 30 may be tentatively formed based on the arrangement of the strands 30A in the third or fifth step. The coils 30 are, for example, tentatively formed in the first step so that they can be readily loosed and rearranged in the third or fifth step. When the coils 30 are tentatively formed based on the final arrangement of the strands 30A, unnecessary tension will not act on the strands 30A when rearranging the strands 30A.

In the method for forming the coils 30, the coils 30 tentatively formed in the first step are reshaped in the third or fifth step when disposed in the slots 60. The coils 30 are disposed in the slots 60 in the third or fifth step, and then the strands 30A of the coils 30 are rearranged. Thus, the coils 30 may be tentatively formed in the first step in conformance with the opening shape of the slots 60. When the coils 30 are tentatively formed in conformance with the opening shape of the slots 60, regardless of the opening shape of the slots 60, the coils 30 are readily wound around the teeth 50.

### Operation

If parts of two coils 30 were to be arranged next to each other in the circumferential direction in each slot 60, there would be a tendency of a gap being formed between the two coils 30. In the radial magnetic bearing 20, parts of two coils 30 are arranged in the radial direction in each slot 60. In each slot 60, parts of the strands 30A of a coil 30 are disposed in the radially outer side of the slot 60, and then, parts of the strands 30A of another coil 30 are disposed in the radially inner side of the slot 60. In the radial magnetic bearing 20 of the present embodiment, parts of two coils 30 are arranged next to each other in the radial direction. This avoids the formation of a gap in the circumferential direction.

### Advantages

The advantages of the present embodiment will now be described.

(1-1) The radial magnetic bearing 20 includes the yoke 40, the teeth 50, the slots 60, the first coil 31, and the second coil 32. A part of the first coil 31 and a part of the second coil 32 are both disposed in a predetermined one of the slots 60. In the predetermined slot 60, the part of the second coil 32 is disposed inward from the part of the first coil 31 in the radial direction.

With this structure, in the predetermined slot 60, the part of the second coil 32 is disposed inward from the part of the first coil 31 in the radial direction. This allows the strands 30A of the second coil 32 to be arranged after the strands 30A of the first coil 31 are arranged. The strands 30A of the first coil 31 are arranged in a manner allowing the part of the first coil 31 disposed in the first region A1 of the predetermined slot 60 to include more strands 30A than in the prior art. Further, the strands 30A of the second coil 32 are arranged in a manner allowing the part of the second coil 32 disposed in the second region A2 of the predetermined slot 60 to include more strands 30A than in the prior art. The radial magnetic bearing 20 allows a large number of the strands 30A of the coils 30 to be arranged in the predetermined slot 60 and avoids the formation of a gap in the predetermined slot 60. This increases the slot fill factor.

In a radial magnetic bearing, if the coils wound around adjacent teeth were to be adjacent to each other in the circumferential direction in a slot, a gap would be formed in the slot. More specifically, a gap extending in the circumferential direction would be formed in the slot between the part of a coil wound around a tooth and the part of coil wound around another tooth. In the radial magnetic bearing 20 of the present embodiment, the coil 30 disposed in the first region A1 and the coil 30 disposed in the second region A2 do not form a gap in the slot 60. Thus, gaps are substantially eliminated from the slots 60. This allows the slot fill factor of the radial magnetic bearing 20 to be increased.

When the strands 30A of a coil 30 are wound around a tooth 50, the strands 30A may become curved on the circumferential side surface of the tooth 50. When the strands 30A are curved such that the coil 30 is bulged, the strands 30A may become separated from the side surface of the tooth 50. When the strands 30A are separated from the tooth 50, a gap will form between the tooth 50 and the strands 30A. This will decrease the slot fill factor. Enlargement of the teeth 50 in the axial direction will increase the curvature of the strands 30A on the side surface of each tooth 50. This will result in a tendency of a large gap forming between the tooth 50 and the strands 30A. In the radial magnetic bearing 20, a part of the second coil 32 is disposed inward in the radial direction from a part of the first coil 31. This facilitates the arrangement of the strands 30A in a manner reducing curving of the strands 30A. By reducing curving of the strands 30A, the strands 30A can be disposed in the predetermined slot 60 so as to limit the formation of a gap between the teeth 50 and the strands 30A. The radial magnetic bearing 20 limits decreases in the slot fill factor even if enlargement of the radial magnetic bearing 20 results in enlargement of the teeth 50 in the axial direction.

When the coils 30 are wound around the teeth 50, the strands 30A of the coils 30 are inserted radially outward from the opening of each slot 60. Thus. it is difficult to adjust the position of the strands 30A in the circumferential direction. In the predetermined slot 60, when the coils 30 are arranged next to each other in the circumferential direction, it is difficult to adjust the position of the strands 30A in the circumferential direction while keeping the coils 30 insulated. In the predetermined slot 60 of the radial magnetic bearing 20, the first coil 31 and the second coil 32 are arranged next to each other in the radial direction. This allows an insulated state to be maintained after the first coil 31 is disposed when disposing the second coil 32.

The strands 30A are arranged in the predetermined slot 60. Thus, the strands 30A are disposed without forming gaps in the predetermined slot 60 as viewed in the axial direction. The number of winds is set in accordance with the cross-sectional area of the strands 30A. Thus, the radial magnetic bearing 20 allows the number of winds of the coils 30 to be set in a preferable manner.

The radial magnetic bearing 20 allows the strands 30A to be disposed in the predetermined slot 60 without forming gaps. This allows the teeth 50 to be increased in width in the circumferential direction while maintaining the number of the strands 30A passing through the slots 60. The radial magnetic bearing 20 allows the teeth 50 to be enlarged thereby decreasing the slots 60 in number. This increases the freedom of design.

(1-2) The teeth 50 includes the first tooth 51, the second tooth 52, the third tooth 53, and the fourth tooth 54. The slots 60 include the first slot 61, the second slot 62, and the third slot 63. The first coil 31 is wound around the second tooth 52. The second coil 32 is wound around the third tooth 53. The first coil 31 includes the first part 31A and the second part 31B. The second coil 32 includes the third part 32A and the fourth part 32B. In the second slot 62, the third part 32A is disposed inward from the second part 31B in the radial direction.

With this structure, in the second slot 62, the second part 31B of the first coil 31 is disposed outward in the radial direction from the third part 32A of the second coil 32. This allows the strands 30A in the second part 31B of the first coil 31 to be arranged in the second slot 62 before the strands 30A in the third part 32A of the second coil 32. By disposing the strands 30A in the second slot 62 in this manner, the strands 30A disposed in the second slot 62 increases the slot fill factor.

(1-3) The teeth 50 include the fifth tooth 55. The slots 60 include the fourth slot 64 surrounded by the yoke 40, the fourth tooth 54, and the fifth tooth 55. The radial magnetic bearing 20 includes the third coil 33 wound around the fourth tooth 54. The third coil 33 includes the fifth part 33A and the sixth part 33B. In the third slot 63, the fifth part 33A is disposed outward from the fourth part 32B in the radial direction.

With this structure, in the second slot 62, the third part 32A of the second coil 32 is disposed inward in the radial direction from the second part 31B of the first coil 31. Further, in the third slot 63, the fourth part 32B of the second coil 32 is disposed inward in the radial direction from the fifth part 33A of the third coil 33. When disposing the coils 30 on the teeth 50, the first coil 31 is wound around the second tooth 52, the third coil 33 is wound around the fourth tooth 54, and the second coil 32 is wound around the third tooth 53. The first coil 31 and the third coil 33 are disposed before the second coil 32. This allows the coils 30 of the radial magnetic bearing 20 to be disposed in a preferred manner.

(1-4) The first coil 31 and the second coil 32 are electrically connected. With this structure, the electrical connection of the first coil 31 and the second coil 32 allow the electromagnetic force of the first coil 31 and the second coil 32 to be controlled simultaneously. The controller 18 simultaneously controls the electromagnetic force of the first coil 31 and the second coil 32. This allows the radial magnetic bearing 20 to support the rotating body 12 in a preferred manner.

(1-5) The radial magnetic bearing 20 includes the insulator 85. With this structure, the first coil 31 and the second coil 32 are insulated in the predetermined slot 60. The insulator 85 is disposed in the second slot 62 after the strands 30A of the first coil 31 are arranged in the predetermined slot 60. The third part 32A of the second coil 32 is inserted into the radial direction from the opening of the second slot 62 to dispose the strands 30A of the second coil 32 in the second slot 62 where the insulator 85 is disposed. The strands 30A of the second coil 32 are disposed in the predetermined slot 60 while the insulator 85 keeps the first coil 31 insulated from the second coil 32.

(1-6) The teeth 50 each include the coil winding portion 86 and the coil stopper portion 87. In the circumferential direction, the dimension Z1 of the coil stopper portion 87 is larger than the dimension Z2 of the coil winding portion 86. With this structure, the coil stopper portion 87 restricts radially inward movement of the coil 30 on the corresponding tooth 50. Thus, the radial magnetic bearing 20 restricts separation of the coils 30 from the teeth 50.

(1-7) The radial magnetic bearing 20 includes the coil positioning member 88. The coil positioning member 88 is located inward in the radial direction from the first coil 31 and the second coil 32. With this structure, the coil positioning member 88 restricts radially inward movement of the first coil 31 and the second coil 32 with respect to the teeth 50 in the predetermined slot 60.

There may be a case in which an insulating member is used in the radial magnetic bearing 20 to restrict movement of the coils 30 with respect to the teeth 50 when winding coils 30 around the teeth 50. In this respect, the radial magnetic bearing 20 includes the coil positioning member 88 instead of an insulating member to restrict movement of the coils 30 with respect to the teeth 50 in the radial direction. Since the insulating member is omitted, the radial magnetic bearing 20 allows the manufacturing cost to be reduced.

(1-8) The number of turns of the second coil 32 is equal to the number of turns of the first coil 31. The number of turns is equal in the second coil 32 and the first coil 31. Thus, when the radial magnetic bearing 20 is energized, the electromagnetic force generated by the first coil 31 is equal to the electromagnetic force generated by the second coil 32. The equal electromagnetic forces generated by the first coil 31 and the second coil 32 allows the controller 18 to execute control for supporting the rotating body 12 with the radial magnetic bearing 20.

(1-9) The predetermined slot 60 includes the first region A1 and the second region A2. In the radial direction, the dimension X2 of the second region A2 is larger than the dimension X1 of the first region A1. This allows the number of the strands 30A forming a part of the second coil 32 to be the same as the number of the strands 30A forming a part of the first coil 31. The predetermined slot 60 is formed so that the width in the circumferential direction decreases toward the radially inner side. Thus, the radial magnetic bearing 20 allows the strands 30A to be disposed in the first region A1 and the second region A2 in conformance with the shape of the predetermined slot 60.

(1-10) The predetermined slot 60 includes the first region A1 and the second region A2. In the circumferential direction, the dimension Y2 of the second region A2 is smaller than the dimension Y1 of the first region A1. This allows a part of the second coil 32 to be disposed in the second region A2 of which the dimension Y2 in the circumferential direction is smaller than the dimension Y1 of the first region A1.

(1-11) The predetermined slot 60 includes the first region A1 and the second region A2. The second region A2 is equal in area to the first region A1 as viewed in the axial direction of the yoke 40. This allows the number of the strands 30A forming a part of the second coil 32 to be the same as the number of the strands 30A forming a part of the first coil 31.

(1-12) The radial magnetic bearing 20 includes the first additional coil 71 and the second additional coil 72. The radial magnetic bearing 20 includes the first coil group G1 and the second coil group G2. In this structure, the first coil 31 faces the first additional coil 71, and the second coil 32 faces the second additional coil 72. Thus, the first coil group G1 faces the second coil group G2. This allows the radial magnetic bearing 20 to support the rotating body 12 in a non-contact manner with the electromagnetic force of the first coil group G1 and the electromagnetic force of the second coil group G2.

(1-13) The compressor 10 includes the rotating body 12 and the radial magnetic bearing 20. In this structure, the slot fill factor of the radial magnetic bearing 20 is increased. This allows the first coil 31 and the second coil 32 to generate electromagnetic force so that the radial magnetic bearing 20 supports the rotating body 12 in a preferred manner. By supporting the rotating body 12 with the radial magnetic bearing 20 in a non-contact manner, the friction loss of the rotating body 12 can be drastically reduced as compared with when the rotating body 12 is contact-supported. The reduced friction loss of the rotating body 12 increases the efficiency of the compressor 10.

(1-14) The refrigeration machine 1 includes the compressor 10. The compressor 10 compresses refrigerant and thereby limits decreases in the energy efficiency.

### Second Embodiment

A refrigeration machine 1, a compressor 10, and a radial magnetic bearing 20 in accordance with a second embodiment will now be described with reference to FIG. 6. In the refrigeration machine 1, the compressor 10, and the radial magnetic bearing 20 of the present embodiment, the same reference numerals are given to those components that are the same as the corresponding components of the first embodiment. Such components will not be described in detail.

As shown in FIG. 6, in the present embodiment, the strands 30A are wound around the teeth 50 inclined with respect to the radial direction. In the present embodiment, when the strands 30A of the coils 30 are disposed in the first region A1 of a slot 60, the strands 30A of the coils 30 are also disposed in the second region A2 of the adjacent slot 60.

The first part 31A of the first coil 31 is disposed in the second region A2 of a slot 60, and the second part 31B of the first coil 31 is disposed in the first region A1 of the slot 60 adjacent to the slot 60 where the first part 31A is disposed. The first part 31A of the first coil 31 is disposed in the second region A2 of the first slot 61, and the second part 31B of the first coil 31 is disposed in the first region A1 of the second slot 62. The third part 32A of the second coil 32 is disposed in the second region A2 of a slot 60, and the fourth part 32B of the second coil 32 is disposed in the first region A1 of the slot 60 adjacent to the slot 60 where the third part 32A is disposed. The third part 32A of the second coil 32 is disposed in the second region A2 of the second slot 62, and the fourth part 32B of the second coil 32 is disposed in the first region A1 of the third slot 63.

In the present embodiment, the first part 31A of the first coil 31 and the third part 32A of the second coil 32 are disposed at opposite sides of the second tooth 52 and located at overlapping positions in the circumferential direction. In the present embodiment, the second part 31B of the first coil 31 and the fourth part 32B of the second coil 32 are disposed at opposite sides of the third tooth 53 and located at overlapping positions in the circumferential direction. In the present embodiment, the third part 32A of the second coil 32 and the fifth part 33A of the third coil 33 are disposed at opposite sides of the third tooth 53 and located at overlapping positions in the circumferential direction. In the present embodiment, the fourth part 32B of the second coil 32 and the sixth part 33B of the third coil 33 are disposed at opposite sides of the fourth tooth 54 and located at overlapping positions in the circumferential direction. In the present embodiment, the fifth part 33A of the third coil 33 and the seventh part 34A of the fourth coil 34 are disposed at opposite sides of the fourth tooth 54 and located at overlapping positions in the circumferential direction. In the present embodiment, the sixth part 33B of the third coil 33 and the eighth part 34B of the fourth coil 34 are disposed at opposite sides of the fifth tooth 55 and located at overlapping positions in the circumferential direction. In the present embodiment, in the third slot 63, the fifth part 33A is disposed inward from the fourth part 32B in the radial direction.

### Coil Formation Method

A method for forming the coils 30 in the present embodiment will now be described.

The method for forming the coils 30 in the present embodiment includes a first step, a seventh step, an eighth step, a ninth step, and a tenth step. The first step of the present embodiment is the same as the first embodiment of the first embodiment and thus will not be described.

The seventh step disposes one end of a coil 30 in the first region A1 of a slot 60. In the seventh step, one end of a coil 30 is inserted into the opening of every one of the slots 60. This disposes one end of a coil 30 in the first region A1 of each slot 60. In the seventh step, the other end of the coil 30 is not inserted into the opening of a slot 60.

In the eighth step, the other end of the coil 30 is disposed in the second region A2 of a slot 60. In the eighth step, in a state in which one end of a coil 30 is disposed in the first region A1 of a slot 60, the other end of the coil 30 is inserted into the opening of the adjacent slot 60. In this manner, each coil 30 is disposed so that one end is located in the first region A1 of the slot 60 and the other end is located in the second region A2 of the adjacent slot 60. In the example of FIG. 6, an adjacent slot 60 is a slot 60 that is adjacent in a direction opposite the first circumferential direction CD1.

The ninth step rearranges the strands 30A of the coils 30 in the slots 60 to reshape the coils 30. In the ninth step, the strands 30A are arranged in the first region A1 and the second region A2. This disposes the strands 30A in the first region A1 and the second region A2 of the slot 60.

The tenth step electrically connects the coils 30. In the tenth step, the strands 30A of the coils 30 are electrically connected.

### Operation

The operation of the present embodiment will now be described.

In the radial magnetic bearing 20 of the present embodiment, one end of a coil 30 is disposed in the first region A1 of the predetermined slot 60, and the other end of the coil 30 is disposed in the second region A2 of the slot 60 adjacent to the predetermined slot 60. In the predetermined slot 60, the coil 30 disposed in the second region A2 restricts radially inward movement of the coil 30 disposed in the first region A1. A coil 30 having one end disposed in the first region A1 has another end disposed in the second region A2 of the slot 60 adjacent to the predetermined slot 60. Radially inward movement of the coil 30 having the other end disposed in the second region A2 of the predetermined slot 60 is restricted by the coil 30 disposed in the second region A2 of the slot 60 adjacent to the predetermined slot 60. The coils 30 restrict each other from moving in the radially inward direction. This allows the coils 30 to be disposed on the teeth 50 in a preferred manner.

### Advantages

The advantages of the present embodiment will now be described.

(2) The teeth 50 includes the fifth tooth 55. The slots 60 include the fourth slot 64 surrounded by the yoke 40, the fourth tooth 54, and the fifth tooth 55. The radial magnetic bearing 20 includes the third coil 33 wound around the fourth tooth 54. The third coil 33 includes the fifth part 33A and the sixth part 33B. In the third slot 63, the fifth part 33A is disposed inward from the fourth part 32B in the radial direction.

With this structure, in the second slot 62, the third part 32A of the second coil 32 restricts radial inward movement of the second part 31B of the first coil 31. Further, in the third slot 63, the fifth part 33A of the third coil 33 restricts radial inward movement of the fourth part 32B of the second coil 32. In this manner, the first coil 31, the second coil 32, and the third coil 33 are disposed so that the coils 30 restrict each other from moving in the radially inward direction. This restricts separation of the coils 30 from the teeth 50.

### Modified Examples

The radial magnetic bearing, the compressor, and the refrigeration machine in accordance with the present disclosure is applicable to, for example, modified examples of the above embodiments that are described below and combinations of at least two of the modified examples that do not contradict each other.

As shown in FIG. 7, in the first embodiment, the coils 30 do not have to include the first connection 82, the second connection 83, and the third connection 84. In the present modified example, the first coil 31, the second coil 32, the third coil 33, and the fourth coil 34 are formed from a single strand 30A. The radial magnetic bearing 20 of the present modified example allows the sixth or tenth step to be omitted from the method for forming the coils 30.

As long as the first coil 31 can be insulated from the second coil 32 in the predetermined slot 60, the insulator 85 may be omitted from the radial magnetic bearing 20. In the present modified example, the first region A1 of each slot 60, for example, extends in the radial direction from a first boundary plane to the inner circumferential surface of the yoke 40. In the present modified example, the second region A2 of each slot 60, for example, extends in the radial direction from the outer circumferential surface of the corresponding coil positioning member 88 to the first boundary plane. The first boundary plane is, for example, a hypothetical plane extending in the circumferential direction between the two coils 30 disposed in each slot 60.

The coil positioning members 88 may be omitted from the radial magnetic bearing 20. In the present modified example, the second region A2 of each slot, for example, extends in the radial direction from a second boundary plane to where the corresponding insulator 85 is located. The second boundary plane is, for example, a hypothetical plane extending in the circumferential direction and located radially inward from the two coils 30 disposed in each slot 60. The second boundary plane is located radially outward from the opening of each slot 60.

The coil stopper portion 87 may be omitted from each tooth 50.

As long as the radial magnetic bearing 20 can support the rotating body 12 in a non-contact manner, the number of turns of the second coil 32 may differ from the number of turns of the first coil 31.

Multiple coils 30 may be wound around a tooth 50. When two coils 30 are wound around a single tooth 50, the second region A2 may include, for example, a third region and a fourth region located radially inward from the third region. For example, one of the two coils 30 wound around a tooth 50 is disposed in the third region, and the other one of the two coils 30 wound around the tooth 50 is disposed in the fourth region.

The radial magnetic bearing 20 may be arranged in a device or a system other than the compressor 10. A device or system other than the compressor 10 includes, for example, a blower device, a pump device, a spindle, or the like.

The compressor 10 may include a plurality of impellers 13 and a plurality of impeller housings S1.

The compressor 10 may include a plurality of thrust magnetic bearings 15.

The thrust magnetic bearing 15 of the compressor 10 may be located at any position in the motor housing S2. In a direction parallel to the rotation axis R1, the thrust magnetic bearing 15 may be disposed, for example, between the second touchdown bearing 16B and the second radial electromagnet 20B, between the second radial electromagnet 20B and the motor 14, between the motor 14 and the first radial electromagnet 20A, between the first radial electromagnet 20A and the first touchdown bearing 16A, or between the first touchdown bearing 16A and the wall 11A.

The compressor 10 may be arranged in a device or a system other than the refrigeration machine 1. A device or system other than the refrigeration machine 1 includes, for example, an air condition, a heat pump device, or the like.

Embodiments and modified examples of the refrigeration machine, the compressor, and the radial magnetic bearing have been described above. It is obvious that various changes in form and detail may be made without departing from the spirit and scope of the refrigeration machine, the compressor, and the radial magnetic bearing as set forth in the appended claims.

1. A radial magnetic bearing configured to support a rotating body, the radial magnetic bearing comprising:
a tubular yoke;
teeth projecting inward from the yoke in a radial direction of the yoke, the teeth being spaced apart in a circumferential direction of the yoke;
slots surrounded by the teeth and the yoke, the slots being open inward in the radial direction;
a first coil wound around one of the teeth; and
a second coil wound around an other one of the teeth different from the one of the teeth around which the first coil is wound,
a part of the first coil and a part of the second coil being both disposed in a predetermined one of the slots, and
in the predetermined one of the slots, the part of the second coil being disposed inward from the part of first coil in the radial direction.

2. The radial magnetic bearing according to claim 1, wherein
the teeth include
a first tooth,
a second tooth spaced apart from the first tooth in a first circumferential direction,
a third tooth spaced apart from the second tooth in the first circumferential direction, and
a fourth tooth spaced apart from the third tooth in the first circumferential direction,
the slots include
a first slot surrounded by the yoke, the first tooth, and the second tooth,
a second slot surrounded by the yoke, the second tooth, and the third tooth, and
a third slot surrounded by the yoke, the third tooth, and the fourth tooth,
the first coil is wound around the second tooth,
the second coil is wound around the third tooth,
the first coil includes a first part disposed in the first slot, and a second part disposed in the second slot,
the second coil includes a third part disposed in the second slot, and a fourth part disposed in the third slot, and
in the second slot, the third part is disposed inward from the second part in the radial direction.

3. The radial magnetic bearing according to claim 2, wherein
the teeth include a fifth tooth spaced apart from the fourth tooth in the first circumferential direction,
the slots include a fourth slot surrounded by the yoke, the fourth tooth, and the fifth tooth,
the radial magnetic bearing further comprises a third coil wound around the fourth tooth,
the third coil includes a fifth part disposed in the third slot, and a sixth part disposed in the fourth slot, and
in the third slot, the fifth part is disposed outward from the fourth part in the radial direction.

4. The radial magnetic bearing according to claim 2, wherein
the teeth include a fifth tooth spaced apart from the fourth tooth in the first circumferential direction,
the slots include a fourth slot surrounded by the yoke, the fourth tooth, and the fifth tooth,
the radial magnetic bearing further comprises a third coil wound around the fourth tooth,
the third coil includes a fifth part disposed in the third slot, and a sixth part disposed in the fourth slot, and
in the third slot, the fifth part is disposed inward from the fourth part in the radial direction.

5. The radial magnetic bearing according to claim 1, wherein
the first coil and the second coil are electrically connected.

6. The radial magnetic bearing according to claim 1, further comprising:
an insulator disposed in the predetermined one of the slots between a part of the first coil and a part of the second coil in the radial direction.

7. The radial magnetic bearing according to claim 1, wherein
the teeth each include
a coil winding portion around which a coil is wound, and
a coil stopper portion located inward from the coil winding portion in the radial direction,
the coil stopper portion having a larger dimension in the circumferential direction than the coil winding portion.

8. The radial magnetic bearing according to claim 1, further comprising:
a coil positioning member disposed in the predetermined one of the slots and extending in the circumferential direction
from a side surface of one of the teeth located at opposite sides of the predetermined one of the slots
to a side surface of the other one of the teeth located at opposite sides of the predetermined one of the slots,
the coil positioning member being located inward from the first coil and the second coil in the radial direction.

9. The radial magnetic bearing according to claim 1, wherein
the second coil has a number of turns equal to a number of turns of the first coil.

10. The radial magnetic bearing according to claim 1, wherein
the predetermined one of the slots includes
a first region where the part of the first coil is disposed, and
a second region where the part of the second coil is disposed, and
the second region has a larger dimension in the radial direction than the first region.

11. The radial magnetic bearing according to claim 1, wherein
the predetermined one of the slots includes
a first region where the part of the first coil is disposed, and
a second region where the part of the second coil is disposed, and
the second region has a smaller dimension in the circumferential direction than the first region.

12. The radial magnetic bearing according to claim 1, wherein
the predetermined one of the slots includes
a first region where the part of the first coil is disposed, and
a second region where the part of the second coil is disposed, and
the second region is equal in an area to the first region as viewed in an axial direction of the yoke.

13. The radial magnetic bearing according to claim 1, further comprising:
a first additional coil wound around a tooth facing, in a first direction orthogonal to an axial direction of the yoke, the one of the teeth around which the first coil is wound;
a second additional coil wound around a tooth facing, in a second direction orthogonal to the axial direction of the yoke, the other one of the teeth around which the second coil is wound;
a first coil group including the first coil and the second coil; and
a second coil group including the first additional coil and the second additional coil.

14. A compressor including the radial magnetic bearing according to claim 1, the compressor further comprising:
a rotating body.

15. A refrigeration machine including the compressor according to claim 14.
